(19) United States
(12) Patent Application Publication
(10) Pub. No.: US 2010/0321465 A1
(43) Pub. Date: Dec. 23, 2010

(54) Method, System and Computer Program Product for Mobile Telepresence Interactions

(75) Inventor: Dominique A. Behrens, Lake Forest, FL (US)

Correspondence Address: Dominique A. Behrens, 646 Broadoak Loop, Lake Forest, FL, 32771, US

(73) Assignee: Dominique A Behrens PA, Lake Forest, FL (US)

(21) Appl. No.: 12/819,159

(22) Filed: Jun. 18, 2010

Related U.S. Application Data
(60) Provisional application No. 61/269,009, filed on Jun. 19, 2009.

(51) Int. Cl. H04N 7/14; G10L 15/26; G06F 17/28

(52) U.S. Cl. 348/14.02; 704/235; 704/3; 348/E07.077; 704/E15.043

(57) ABSTRACT

A method, system and computer program product includes transmitting, at least partially over a first wireless link from a first mobile communications client to at least one server, a first request for creating a first telepresence session. Transmitting, at least partially over the first wireless link from the first mobile communications client to the at least one server, telepresence information comprising at least a list of attendees and a scheduled time. Acknowledging the at least one server receiving a second request, transmitted at least partially over a second wireless link from a second mobile communications client to the at least one server, to join the first telepresence session. Engaging in a real-time telepresence session, created by the first request and the second request, at the scheduled time, wherein users of the first mobile communications client and the second mobile communications client are enabled to participate in telepresence interactions.

### CROSS-REFERENCE TO RELATED APPLICATIONS

The present Utility patent application claims priority benefit of the U.S. provisional application for patent Ser. No. 61/269,009 and entitled “100% realty concept and virtual realty network”, filed on Jun. 19, 2009 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to the field of computer supported collaborative work between pluralities of users.

More particularly, the invention relates to a system for capturing and transmitting, via mobile communication devices, images and audio of the user and the user's immediate surroundings as well as receiving images and audio from one or more parties via a network connection in order to perform mobile collaborative telepresence interaction.

### BACKGROUND OF THE INVENTION

Collaborative work often requires one or more parties to physically travel to a location where the work is to be performed. For example, an expert technician from headquarters may travel to a plant location to assist the local technician in troubleshooting and correcting an equipment problem. The travel time required can be time consuming and expensive and can result in substantial delays in remedying a manufacturing issue requiring specialized technical expertise. In addition to technical field service, other non-limiting examples where a visual means of collaborating on a task might be preferred over travel include security operations, home healthcare, emergency services, real-estate sales, various types of training and building inspections.

While the telephone is a useful means of communicating over long distances, the absence of a real-time visual component limits its effectiveness in situations where verbal description is inadequate. Videoconferencing has evolved to include dedicated as well as desktop personal computer-based systems that allow two or more parties to observe each other via images transmitted across a computer network. Typically, each party sits in front of a video camera used to capture the image to be sent and a Graphical User Interface (GUI) for displaying the image captured by the video camera. A microphone and speaker assembly operates in a similar fashion for the transmission of audio. Images generated using a personal computer or video recording device may also be transmitted and received.

Telepresence takes teleconferencing to a new level allowing participants to feel as if other participants are located in close proximity. Telepresence requires increased fidelity for video and audio to be effective. The high fidelity requirement for audio and video requires large amounts of processing power and communication bandwidth. Due to the large amount of processing power and communication bandwidth required, conventional telepresence systems are bulky and difficult to transport. Furthermore, conventional telepresence systems rely on conventional computer operating systems for document sharing which are not designed or developed with the intent of performing an effective collaborative telepresence interaction and as a result are cumbersome with respect to performing tasks for remote collaboration. Furthermore, conventional telepresence equipment is very expensive so it is desirable for succeeding generations of telepresence equipment to be operable to interface with previous generations of telepresence equipment.

FIG. 1A is a block diagram depicting a conventional client/server telepresence communication system which may be used by an exemplary web-enabled/networked embodiment or embodiments of the present invention.

A telepresence communication system 100 includes a includes a multiplicity of clients with a sampling of clients denoted as a client 102 and a client 104, a multiplicity of servers with a sampling of servers denoted as a server device 106 and a server device 108, a multiplicity of local networks with a sampling of local networks denoted as a local network 110 and a local network 112, a global network 114.

Client 102 may communicate bi-directionally with local network 110 via a communication channel 116. Client 104 may communicate bi-directionally with local network 110 via a communication channel 118. Local network 110 may communicate bi-directionally with global network 114 via a communication channel 120. Local network 112 may communicate bi-directionally with global network 114 via a communication channel 126. Local network 112 may communicate bi-directionally with server device 106 via a communication channel 122. Local network 112 may communicate bi-directionally with server device 108 via a communication channel 124. Furthermore, clients 102, 104, server device 106 and server device 108, local networks 110, 112 and global network 114 may each communicate bi-directionally with each other.

In one embodiment, global network 114 may operate as the Internet. It will be understood by those skilled in the art that telepresence communication system 100 may take many different forms. Non-limiting examples of forms for telepresence communication system 100 include local area networks (LANs), wide area networks (WANs), wired telephone networks, or any other network supporting data communication between respective entities via hardwired communication networks.

Client 102 includes a video capture device 128, a processor 130, a microphone 132, a GUI 134, an interface device 136, an audio device 137 and a network device 138. Processor 130 is operable to receive video from video capture device 128 via a communication channel 140. Non-limiting examples of video capture devices include video camera, webcam and camera. Processor 130 is operable to receive audio from microphone 132 via a communication channel 144. GUI 134 is operable to receive display information from processor 130 via a communication channel 146. Processor 130 is operable to receive control information from interface device 136 via a communication channel 142. Non-limiting examples of interface device 136 include pointing device, trackball, touch-pad, keyboard, telephone, facsimile scanner, printer and telephone. Audio device 137 may receive audio information from processor 130 via a communication channel 143. Non-limiting examples of audio device 137 include speakers, headphones and ear buds. Processor 130 may communicate bi-directionally with network device 138 via a communication channel 148.

Server device 106 includes a network device 150 and a server 152. Network device 150 may communicate bi-directionally with server 152 via a communication channel 154. Network device 150 may communicate with external devices via communication channel 122.

Client 102 and 104 may be operable to provide telepresence capabilities. Users (not shown) may operate to use client 102 and 104 for communicating and collaborating remotely. Video information captured by video capture device 128 and microphone 132 may be transferred to processor 130 via communication channel 140 (video) and communication channel 144 (audio). Processor 130 may then communicate the captured audio/video information to network device 138 via communication channel 148. Network device 138 may communicate the captured audio/video information to local network 110 via communication channel 116. Local network 110 may then communicate the captured audio/video information to global network 114 via communication channel 120. Global network 114 may then communicate the captured audio/video information to local network 112 via communication channel 126. Local network 112 may then communicate the captured audio/video information to network device 150 via communication channel 122. Network device 150 may communicate the captured audio/video information to server 152 via communication channel 154. Server 152 may then operate to process the audio/video. Non-limiting examples for processing which may be applied to the audio/video include alpha blending and filtering. Server 152 may then communicate the processed audio/video information to network device 150 via communication channel 154. Network device 150 may communicate the processed audio/video information to local network 112 via communication channel 122. Local network 112 may communicate the processed audio/video information to global network 114 via communication channel 126. Global network 114 may communicate the processed audio/video information to local network 110 via communication channel 120. Local network 110 may communicate the processed audio/video information to client 104 via communication channel 118.

The bi-directional transfer of audio/video between client 102 and client 104 enables users to view other user's facial features and expressions and hear the audio generated by other users. Furthermore, other information may be exchanged between client 102 and client 104 in a similar manner as previously discussed with respect to audio and video. Non-limiting examples of information which may be exchanged includes textual information, graphical information and application files. Non-limiting examples of application files which may be exchanged include word processing and spread sheets.

Conventional telepresence communication system 100 as illustrated in FIG. 1A may comprise large bulky processing equipment which may be difficult to easily transport.

In view of the foregoing, there is a need for improved techniques for providing telepresence capabilities which may be mobile, may interoperate with conventional telepresence capabilities and may also be streamlined for ease of collaborative interaction.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a block diagram depicting a conventional client/server telepresence communication system which may be used by an exemplary web-enabled/networked embodiment or embodiments of the present invention;

FIG. 1B is a block diagram depicting a conventional client/server telepresence communication system as depicted in FIG. 1A with the addition of an exemplary web-enabled/networked embodiment or embodiments of the present invention;

FIG. 2A-F illustrates operation of exemplary software and software applications which may be used by an exemplary web-enabled embodiment of the present invention;

FIG. 3 is an exemplary block diagram depicting a telepresence system in accordance with an embodiment of the present invention; and

FIG. 4 illustrates a mobile device that, when appropriately configured or designed, may serve as a mobile device 300 for which the present invention may be embodied.

Unless otherwise indicated illustrations in the figures are not necessarily drawn to scale.

### SUMMARY OF THE INVENTION

To achieve the forgoing and other aspects and in accordance with the purpose of the invention, a method, system and computer program product for mobile telepresence interactions is presented.

In one embodiment a method executing on one or more processors includes steps for transmitting, over a first wireless link, a first mobile request for creating a first telepresence session, steps for transmitting, over the first wireless link, telepresence information comprising at least a list of attendees and a scheduled time, steps for acknowledging a second mobile request, transmitted over a second wireless link, to join the first telepresence session, and steps for engaging in a real-time telepresence session, created by the first mobile request and the second mobile request, at the scheduled time, wherein users are enabled to participate in telepresence interactions. Another embodiment further includes steps for acknowledging a fixed location request to join the first telepresence session, wherein a user at a fixed location is enabled to participate in the telepresence interactions. Yet another embodiment further includes steps for receiving one or more telepresence applications utilizing a open application programming interface for extending the telepresence interactions. Still another embodiment further includes steps for receiving a list of available telepresence sessions for enabling selection of a desired session.

In another embodiment a method executing on one or more processors includes the steps of transmitting, at least partially over a first wireless link from a first mobile communications client to at least one server, a first request for creating a first telepresence session. Steps transmit, at least partially over the first wireless link from the first mobile communications client to the at least one server, telepresence information comprising at least a list of attendees and a scheduled time. Steps acknowledge the at least one server receiving a second request, transmitted at least partially over a second wireless link from a second mobile communications client to the at least one server, to join the first telepresence session. Steps engage in a real-time telepresence session, created by the first request and the second request, at the scheduled time, wherein users of the first mobile communications client and the second mobile communications client are enabled to participate in telepresence interactions. Another embodiment further includes the step of acknowledging the at least one server receiving a third request, from a fixed location communications client, to join the first telepresence session, wherein a user of the fixed location communications client is enabled to participate in the telepresence interactions. In yet another embodiment clients utilize an open application programming interface (API). Still another embodiment further includes the step of receiving, from the at least one server, one or more telepresence applications utilizing the open API for extending the telepresence interactions. Another embodiment further includes the step of receiving, from the at least one server, a list of available telepresence sessions for enabling selection of a desired session. In yet another embodiment the real-time telepresence session further enables document exchange and document viewing. In still another embodiment the telepresence interactions further comprise videoconferencing. In another embodiment the videoconferencing further comprises three-dimensional video. In yet another embodiment audio, associated with the videoconferencing, is converted to subtext for real-time display. In still another embodiment a language conversion is applied to the subtext. In another embodiment the telepresence interactions further comprise webmeetings and webtraining.

In another embodiment a system includes means for engaging in telepresence sessions over wireless links using communications clients, means for connecting the wireless links to enable communication between the engaging means, and means for managing the telepresence sessions, wherein mobile users operating the communications clients are enabled to engage in real-time telepresence sessions and participate in telepresence interactions. Another embodiment further includes means for engaging in the telepresence sessions, over the network, from fixed locations, wherein fixed location users are enabled to engage the mobile users in the real-time telepresence sessions and participate in the telepresence interactions. Yet another embodiment further includes means for extending the telepresence interactions.

In another embodiment a system includes a plurality of mobile communication devices configurable for telepresence sessions over wireless links. Each of the plurality of mobile communication devices includes a communications client. A network connects the wireless links to enable communication between the plurality of mobile communication devices. At least one server, connected to the network, manages the telepresence sessions, wherein mobile users operating the communications clients are enabled to engage in real-time telepresence sessions and participate in telepresence interactions. Another embodiment further includes a plurality of fixed location telepresence sites configured for telepresence sessions over the network, wherein fixed location users are enabled to engage the mobile users in the real-time telepresence sessions and participate in the telepresence interactions. In yet another embodiment the communications clients utilize an open application programming interface (API). Still another embodiment further includes one or more telepresence applications utilizing the open API for extending the telepresence interactions, the one or more telepresence applications being stored on the at least one server. In another embodiment at least one server further manages a list of available telepresence sessions for enabling user selection of a desired session. In yet another embodiment the real-time telepresence sessions further enable document exchange and document viewing. In still another embodiment the telepresence interactions further comprise videoconferencing. In another embodiment the videoconferencing further comprises three-dimensional video. In yet another embodiment audio, associated with the videoconferencing, is converted to subtext for real-time display. In still another embodiment a language conversion is applied to the subtext. In another embodiment the telepresence interactions further comprise webmeetings and webtraining.

In another embodiment a computer program product residing on or being distributed across one or more computer readable mediums having a plurality of instructions stored thereon which, when executed by one or more associated processors, cause the one or more processors to transmit, at least partially over a first wireless link from a first mobile communications client to at least one server, a first request for creating a first telepresence session. One or more associated processors transmit, at least partially over the first wireless link from the first mobile communications client to the at least one server, telepresence information comprising at least a list of attendees and a scheduled time. One or more associated processors acknowledge the at least one server receiving a second request, transmitted at least partially over a second wireless link from a second mobile communications client to the at least one server, to join the first telepresence session. One or more associated processors engage in a real-time telepresence session, created by the first request and the second request, at the scheduled time, wherein users of the first mobile communications client and the second mobile communications client are enabled to participate in telepresence interactions. Another embodiment further includes instructions for acknowledging the at least one server receiving a third request, from a fixed location communications client, to join the first telepresence session, wherein a user of the fixed location communications client is enabled to participate in the telepresence interactions. In yet another embodiment clients utilize an open application programming interface (API). Still another embodiment further includes instructions for receiving, from the at least one server, one or more telepresence applications utilizing the open API for extending the telepresence interactions. Another embodiment further includes instructions for receiving, from the at least one server, a list of available telepresence sessions for enabling selection of a desired session. In yet another embodiment the real-time telepresence session further enables document exchange and document viewing. In still another embodiment the telepresence interactions further comprise videoconferencing. In another embodiment the videoconferencing further comprises three-dimensional video. In yet another embodiment audio, associated with the videoconferencing, is converted to subtext for real-time display. In still another embodiment a language conversion is applied to the subtext. In another embodiment the telepresence interactions further comprise webmeetings and webtraining.

Other features, advantages, and aspects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some preferred embodiments of the present invention provide means and methods for providing telepresence interaction between parties using mobile devices. Some non-limiting examples of mobile devices include, but not limited to, notebook computers, netbook computers, cellular phones, satellite phones, smartphones and personal digital assistants (PDAs), 4G Mobile Devices, iPhones™, iPads™, etc. Non-limiting examples of mobile networking communication mediums include, but not limited to, wireless local area networks (WLANs), wireless cellular telephone networks and wireless satellite networks, 4G WiMAX™, etc. Non-limiting examples of where telepresence interactions occur between parties include, but not limited to, videoconferencing, teleconferencing, webmeetings, webinars, exchange of audio, video, audio/video, facial expressions, body language and eye contact, instant messaging (IM), facsimiles (FAXs), voice messages (VM), training, virtual “integrated” training, virtual network training, webtraining, etc. Further non-limiting examples include, but not limited to, virtual network assistants, creating virtual physical assistants, modifying virtual physical assistants, creating virtual network (VN) incubation elements, modifying VN incubation elements, etc. VN incubation develops, incubates, and assists in the commercialization of novel and promising businesses for profit, social business and nonprofit sectors, with a particular emphasis on the development of start-ups, multi-level marketing (MLM) companies, healthcare, and seminar companies. Additional non-limiting examples include, but not limited to, creating new online businesses, or development of start-up offline businesses or existing brick and mortar businesses, networked to embodiments of the present invention, etc. Preferred embodiments of the present invention enable person-to person communication with video and data broadcasting for real-time business collaboration to allow enable professionals to communicate, train, meet and/or collaborate from anywhere and from any mobile device, in addition—modifying online businesses, creating new marketing entities, modifying new marketing entities, file sharing, online “integrated” virtual offices, online “integrated” virtual space, collaboration, Three-Dimensional Television (3DTV), virtual profit centers, business and consumer network marketing and application execution/interaction. Some embodiments of the present invention enable companies to improve administrative efficiencies to lower overhead expenses for businesses worldwide, develop businesses and minimize unemployment. In accordance with embodiments of the present invention, companies/individuals are enabled access to, but not limited to, virtual office room, 3DTV room, 3DTV meeting room, virtual private assistant, etc.

In other embodiments of the present invention, a method and means for providing voicemail-to-text messaging conversion for telepresence interaction between parties will be described. Voicemail-to-text messaging may be provided for any known language with conversion to text provided in any language. Non-limiting examples of languages which may be converted from and converted to include Sign Language, English, Spanish, German, French, Mandarin Chinese, Hindi, Arabic, Bengali, Portuguese, Russian, Japanese, and Italian. For example, a voice mail message may be recorded in Spanish and converted to an English text message for viewing.

In other embodiments of the present invention, a method and means for providing subtext for telepresence interaction between parties will be described. A subtext of an audio stream may be overlaid on a display of a video stream. Non-limiting examples of audio of languages which may be converted from and to subtext include Sign Language, English, Spanish, German, French, Mandarin Chinese, Hindi, Arabic, Bengali, Portuguese, Russian, Japanese and Italian. For example, a stream of Spanish audio may be converted and displayed in English subtext in real time during a telepresence session.

In other embodiments of the present invention, a method and means for providing open Applications Programming Interface (API) will be described. An open API or APIs may be provided for enabling interaction with software embodiments of the present invention. Non-limiting examples of languages which may be supported via an API interface include, but not limited to, Java, C, C++, C#, SOAP, XML URL API, and Teleconference Service Provider API. Teleconference HW will support open standards, such as H.323, to deliver any-to-any interoperability with standard- and high-definition videoconferencing systems and other collaboration applications. Open APIs may operate to enable third-party hardware and software developers and integrators the ability to interface and interact with the present invention, thereby extending telepresence interactions.

In other embodiments of the present invention, a method and means for providing subleasing, franchising and joint venture partnerships of telepresence capabilities is described. Non-limiting examples of applications or uses where an embodiment or embodiments of the present invention may be used include, but not limited to, primary and secondary education, security operations, home healthcare, emergency services, real-estate sales, various types of training and building inspections businesses, health industry, education, relationship marketing to create jobs, improve administrative efficiencies, to help the poor, the unemployed, lower overhead expenses for businesses worldwide, develop businesses and minimize unemployment, spin off in the health industry, real estate industry—housing for the poor, et al. and to help homeowners in pre-foreclosure. Further examples include, but not limited to, real estate, MLM network marketing third party companies, satellite officing employers, mobile workforce employers with virtual officing et al, CPA's, attorneys, financial consultants, small businesses, corporations in banking industry, network of sales professionals, seminar companies, MLM companies, health care industry, real estate industry (agents, brokers and affiliate partners, focused on the pulse of today's Real estate Market and Banking and Mortgage Industry, pre-foreclosures, foreclosures, short-sales, bank-owned properties, attorney based loan modification services, banks), lending institution, pharmaceutical and medical device industry, etc. Applications or uses of an embodiment or embodiments of the present invention may, across private, public and government sectors, feature virtual officing with satellite offices worldwide with mobile collaboration, enabling mobile professionals to communicate, train, meet and/or collaborate from anywhere and from any device, minimizing fixed overhead expenses (Traditional Office space, hiring staff, utilities, telephone and IT infrastructure continues to remain as fixed overhead expenses for franchisees) thru VN, with added savings and residual income from network marketing which will catalyze profits and economic growth.

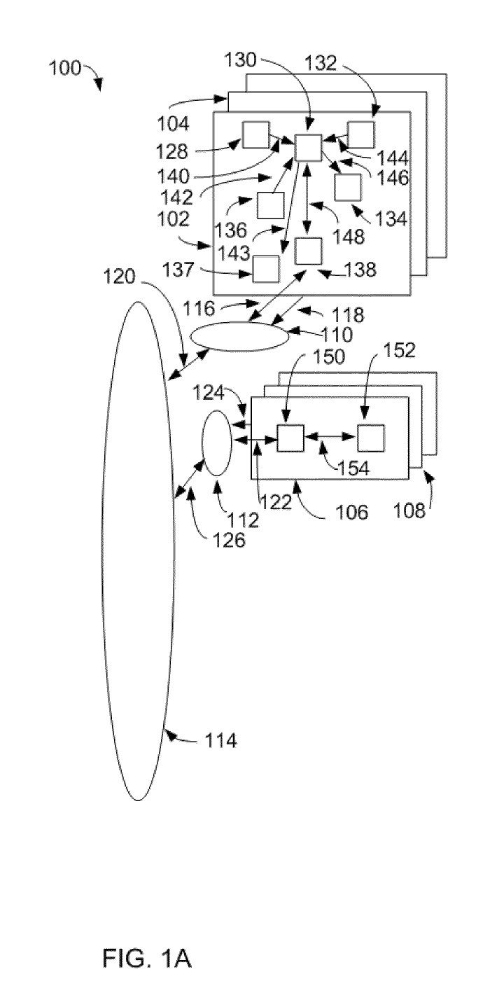

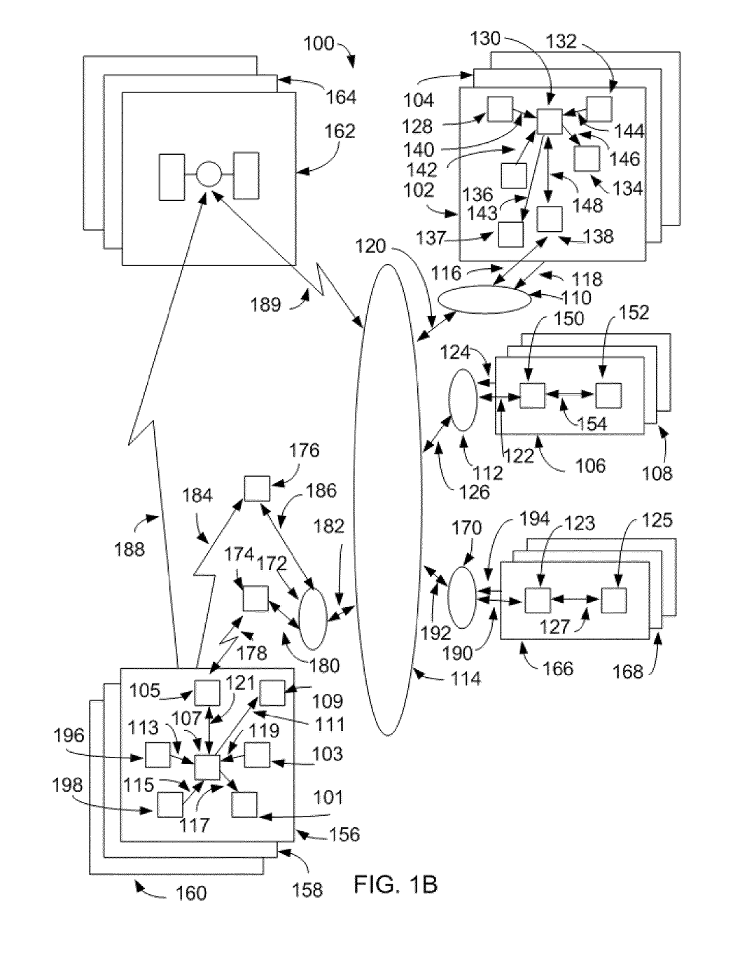

Exemplary embodiments of the present invention will now be added to the conventional elements of FIG. 1A and be illustrated as FIG. 1B.

FIG. 1B is a block diagram depicting a conventional client/server telepresence communication system as depicted in FIG. 1A with the addition of an exemplary web-enabled/networked embodiment or embodiments of the present invention.

The telepresence communication system 199 of FIG. 1B includes all of the elements of FIG. 1A with the addition of a multiplicity of mobile clients with a sampling of mobile clients denoted as a mobile client 156, a mobile client 158 and a mobile client 160, a multiplicity of satellite communication devices with a sampling of satellite communication devices denoted as a satellite communication device 162 and a satellite communication device 164 and a multiplicity of server devices with a sampling of server devices denoted as a server device 166 and a server device 168, a local network 170, a local network 172, a wireless networking device 174 and a wireless networking device 176. Non-limiting examples of mobile clients include notebook computers, netbook computers, cellular phones, satellite phones, smartphones, PDAs, 4G Mobile Devices, iPhones™ and iPads™. Mobile client 156 may communicate bi-directionally with wireless networking device 174 via a wireless communication channel 178. Wireless networking device 174 may communicate bi-directionally with local network 172 via a communication channel 180. Local network 172 may communicate bi-directionally with global network 114 via a communication channel 182. Mobile client 158 may communicate bi-directionally with wireless networking device 176 via a wireless communication channel 184. Wireless networking device 176 may communicate bi-directionally with local network 172 via a communication channel 186. Mobile client 160 may communicate bi-directionally with satellite communication device 162 via a wireless communication channel 188. Satellite communication device 162 may communicate bi-directionally with global network 114 via a communication channel 189. Server device 166 may communicate bi-directionally with local network 170 via a communication channel 190. Local network 170 may communicate bi-directionally with global network 114 via a communication channel 192. Server device 168 may communicate bi-directionally with local network 170 via a communication channel 194.

Mobile client 156 includes a video capture device 196, a microphone 198, a GUI 101, an interface device 103, a wireless networking device 105, a processor 107 and an audio device 109. Processor 107 may receive video information from video capture device 196 via a communication channel 113. Processor 107 may receive audio information from microphone 198 via a communication channel 115. GUI 101 may receive information for display from processor 107 via a communication channel 117. Processor 107 may receive control information from interface device 103 via a communication channel 119. Non-limiting examples for interface device 103 include pointing device, trackball, touch-pad, keyboard telephone, facsimile scanner, printer and telephone. Processor 107 may communicate bi-directionally with wireless networking device 105 via a communication channel 121. Audio device 109 may receive audio information from processor 107 via a communication channel 111. Non-limiting examples of audio device 109 include, but not limited to, speakers, headphones and ear buds.

Server device 166 includes a networking device 123 and a server 125. Networking device 123 may communicate bi-directionally with server 125 via a communication channel 127. Networking device 123 may bi-directionally communicate to networking devices located external to server device 166.

Clients 102 and 104, mobile clients 156, 158 and 160 and server devices 106, 108, 166 and 168 may communicate information bi-directionally with each other via local networks 110, 112, 170 and 172, global network 114, satellite communication devices 162 and 164, wireless networking devices 174 and 176, and communication channels 116, 118, 120, 122 124, 126, 178, 180, 182, 184, 188, 189, 190, 192 and 194. Clients 102 and 104 and mobile clients 156, 158 and 160 may operate to perform telepresence communications with each other. Users (not shown) of clients 102 and 104 and mobile clients 156, 158 and 160 may operate to view video and other information and listen to audio provided by any of the other clients and mobile clients. Furthermore, users may operate to view audio and other information and listen to audio provided by their own clients and mobile clients. Furthermore, via clients and mobile clients users may operate to execute applications and access information located on server devices 106, 108, 166 and 168. Non-limiting examples of applications which may be executed include Instant Messaging (IM), Internet facsimile, Internet voicemail, voicemail conversion-to-text, virtual training room, virtual physical address, virtual incubation center, business and commercial marketing and virtual online business.

FIG. 1B illustrates how exemplary embodiments of the present invention may be added to or interfaced with conventional telepresence elements as illustrated in FIG. 1A in order to provide a telepresence capability which is interoperable and is also mobile.

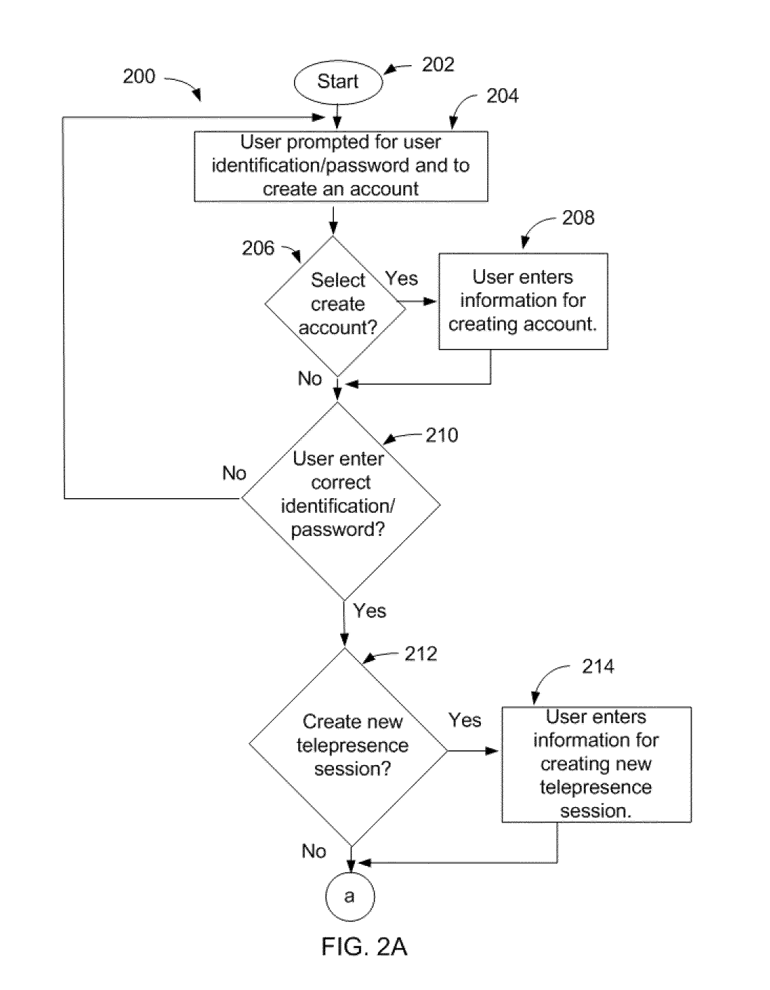

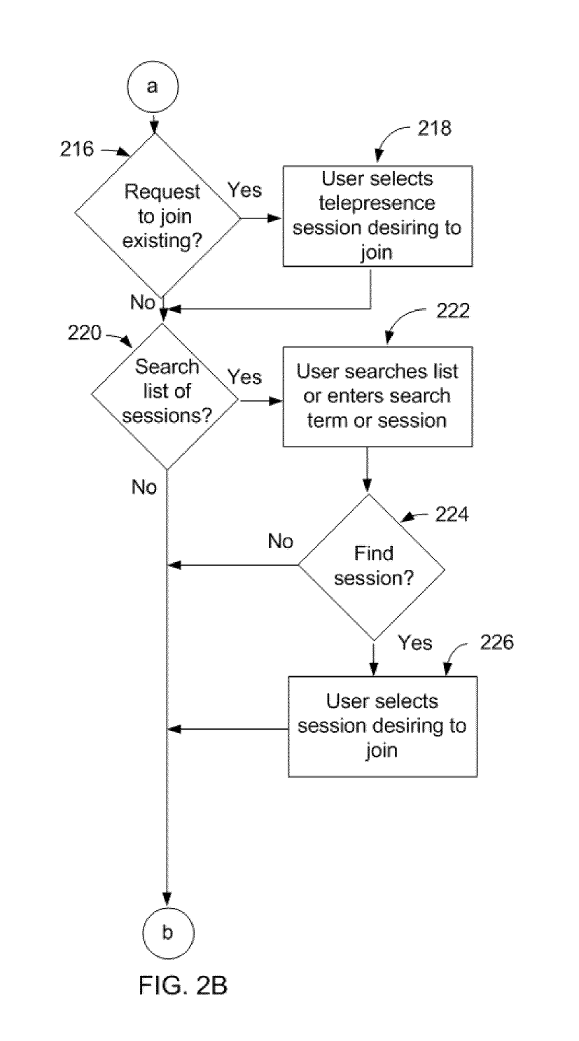

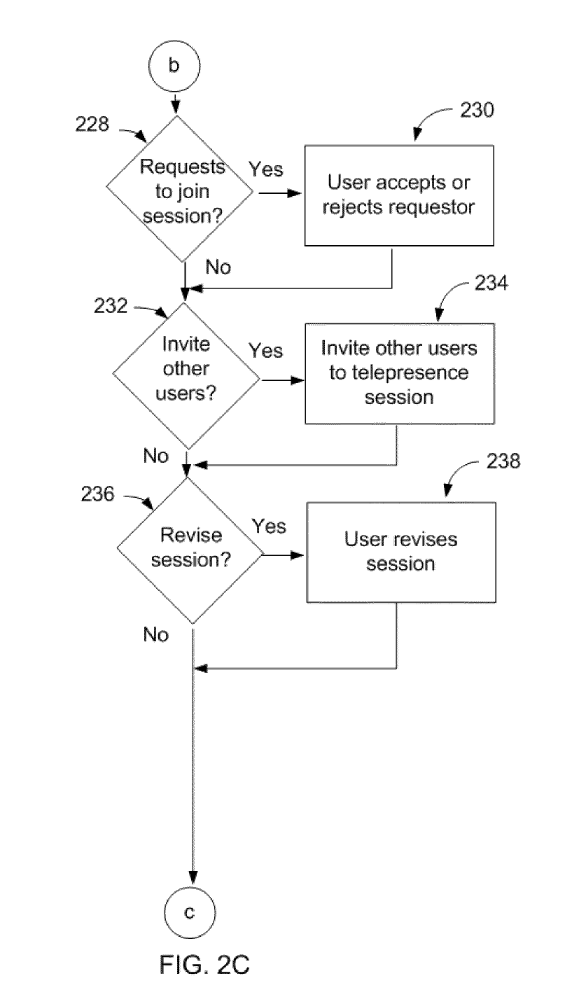

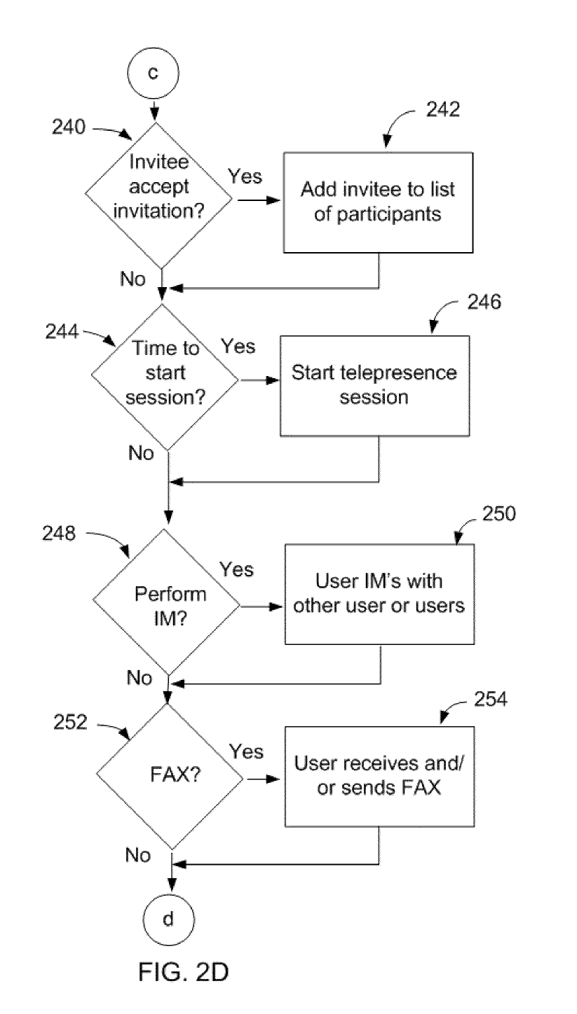

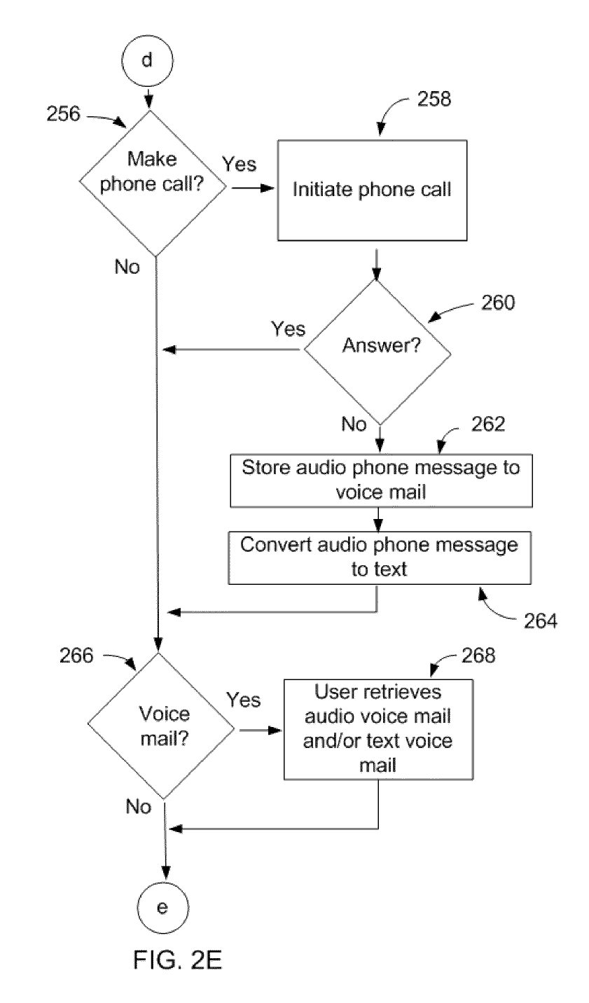

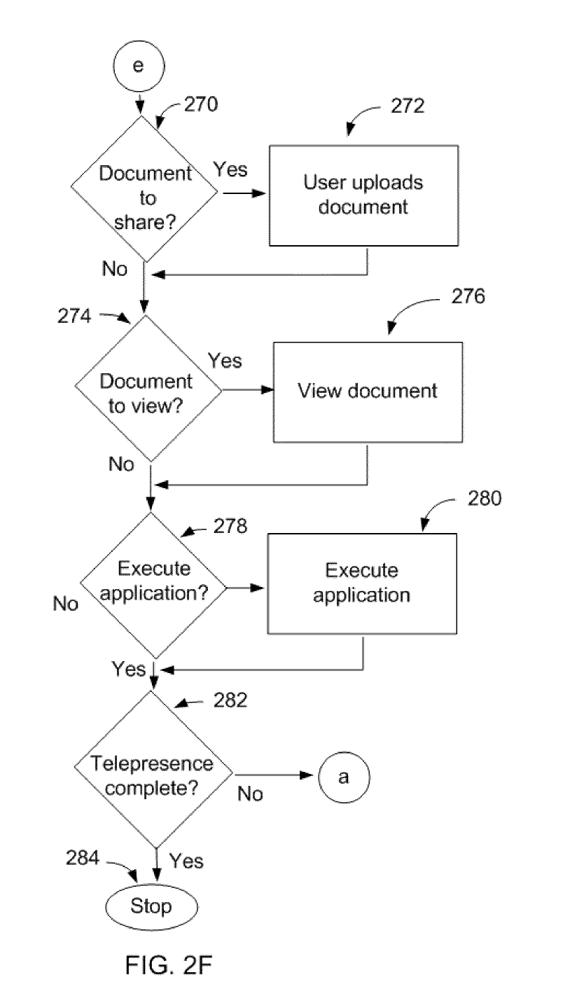

FIG. 2A-F illustrates operation of exemplary software and software applications which may be used by an exemplary web-enabled embodiment of the present invention.

FIG. 2A-F is a flow chart 200 illustrating an exemplary process for the execution of software and software applications in accordance with an embodiment of the present invention. In the present embodiment, the process initiates in a step 202 (FIG. 2A). The software and software applications may be operable for instruction execution and storage of information on server devices 106, 108, 166 and 168 (FIG. 1B). In a step 204 (FIG. 2A), user may be prompted on GUI 101 (FIG. 1B) of mobile client 156 (FIG. 1B) to enter a user identification and password and may also be prompted to create an account. Non-limiting examples of GUIs include computer monitor, cell phone display and television. The information which may be displayed to user via GUI 101 (FIG. 1B) may initiate at server devices 106, 108, 166 and/or server device 168 and may be communicated to GUI 101 via local networks 112, 170 and 172, global network 114, satellite communication devices 162 and 164, wireless networking devices 174 and 176, communication channels 122, 124, 126, 180, 182, 186, 190, 192 and 194 and wireless communication channels 178, 184, 188 and 189. For example, consider software application executing on server device 166. Information to be transmitted to GUI 101 for display to user may be communicated from server 125 to networking device 123 via communication channel 127. Networking device 123 may communicate the display information to local network 170 via communication channel 190. Local network 170 may communication the display information to global network 114 via communication channel 192. Global network 114 may communicate the display information to local network 172 via communication channel 182. Local network 172 may communicate the display information to wireless networking device 174 via communication channel 180. Wireless networking device 174 may communicate the display information to wireless networking device 105 via wireless communication channel 178. Wireless networking device 105 may communicate the display information to processor 107 via communication channel 121. Processor 107 may communicate the display information to GUI 101 via communication channel 117. User may then view the information displayed on GUI 101.

If user has a prior established account, then the user may enter an identification and password. In a step 206 (FIG. 2A), it may be determined if user selects to create an account. If user selects to create an account, then in a step 208 user may enter information for creating an account. Non-limiting examples of information for creating an account include user identification, password, first name, middle name, last name, street address, city, state, zip code, country, phone number, fax number, email address, security questions, credit card type, credit card number, credit card expiration month, credit card expiration year, credit card security code. User may select or input information via interface device 103 (FIG. 1B) for transmittal to server device 166. Input information may be communicated to processor 107 via communication channel 119. Input information may then be communicated to wireless networking device 105 via communication channel 121. Wireless networking device 105 may communicate input information to wireless networking device 174 via wireless communication channel 178. Wireless networking device 174 may communicate the input information to local network 172 via communication channel 180. Local network 172 may communicate the input information to global network 114 via communication channel 182. Global network 114 may communicate the input information to local network 170 via communication channel 192. Local network 170 may communicate the input information to networking device 123 via communication channel 190. Networking device 123 may communicate the input information to server 125 via communication channel 127. Server 125 may operate to perform instructions based on the input information received from interface device 103.

In a step 210 (FIG. 2A), software may determine if user has entered the correct identification and password information. If user enters incorrect user identification and password information, operation of software may return to step 204. In a step 212, it may be determined if a user seeks to create a new telepresence session. If user seeks to create a new telepresence session, then in a step 214 user may enter information for creating a new telepresence session via interface device 103 (FIG. 1B). Non-limiting examples of information which may be entered for creating a new telepresence session include user identification of session creator, user identification(s) of desired attendee(s), date/time for start, date/time for end, title of session, description of session, maximum number of attendees, minimum number of attendees, type of session and agenda. In a step 216 (FIG. 2B), it may determined if user seeks to join an existing telepresence session created by another user. If user seeks to join a telepresence session created by another user, then in a step 218 user may select to join a telepresence session. In a step 220, it may be determined if user seeks to search a list of sessions for attending. If user seeks to search for a telepresence session, then in a step 222 user may search a list of available telepresence sessions or may enter a search term describing a desired telepresence session to join. In a step 224, it may be determined if user has found a telepresence session for joining. If user finds a telepresence to join, then in a step 226 user may select and/or enter information for joining a telepresence session. Non-limiting examples of information user may enter include user identification, name, location, title, affiliation, reason for seeking to join, credentials and credit card information. In a step 228 (FIG. 2C), a user may determine if a secondary user or users has/have requested to join a telepresence session created by user. If a secondary user or users has/have requested to join a telepresence session created by user, then in a step 230 user may opt to accept or reject a secondary user or users requesting to join the telepresence session. In a step 232, it may be determined if user seeks to invite other user or users to a telepresence session. If it is determined user seeks to invite other user or users to a telepresence session, then in a step 234 user may invite other user or users. In a step 236, it may be determined if user seeks to revise a telepresence session. If it is determined user seeks to revise a telepresence session, then in a step 238 user may revise a telepresence session. Non-limiting examples of telepresence revisions which may be executed include date/time, attendees, title, description, agenda and type. In a step 240 (FIG. 2D), it may be determined if a secondary user or users has accepted an invitation to join a telepresence session. If a user or users has accepted an invitation, then in a step 242 the user or users may be added to the list of telepresence participants. In a step 244, it may be determined if it is time to start a telepresence session. If it is determined a telepresence session is to be started, then in a step 246 a telepresence session may be started. In a step 248 it may be determined if an instant messaging or chat session is to be performed between users. If it is determined that an instant messaging or chat session is to be performed between users, then an instant messaging session may be performed in a step 250. In a step 252, it may be determined if a facsimile is to be transmitted. If it is determined a facsimile is to be transmitted, then in a step 254 a facsimile is transmitted. In a step 256 (FIG. 2E), it may be determined if user seeks to execute a phone call. If it is determined user seeks to execute a phone call, then in a step 258 user may execute a phone call. In a step 260, it may be determined if a secondary user answers the phone call. If secondary user does not answer phone call, then in a step 262 user may leave voice mail message and in a step 264 the voice mail message may be converted to textual information. In a step 266, it may be determined if user has a voice mail message. If it is determined user has a voice mail message, then in a step 268 user may listen to audio version of voice mail and/or view textual version of converted voice mail message. In a step 270 (FIG. 2F), it may be determined if a user seeks to share a document with another user. If it is determined user seeks to share a document with another user, then in a step 272 user uploads a document. In a step 274, it is determined if user has a document to view. If it is determined that user has a document to view, then in a step 276 user may view document. In a step 278, it may be determined if user seeks to execute an application. If it is determined user seeks to execute an application, then in a step 280, user may execute an application. Non-limiting examples of applications which may be executed include training, creating physical assistant, creating new incubation, creating new business, modify existing business, creating marketing entity, modifying existing marketing entity and remediation of malicious software. In a step 282, it may be determined if a telepresence session has been completed. If it is determined telepresence session has not terminated, then operation of software returns to step 216 (FIG. 2B). If it is determined telepresence session has terminated, then operation of software transitions to a step 284.

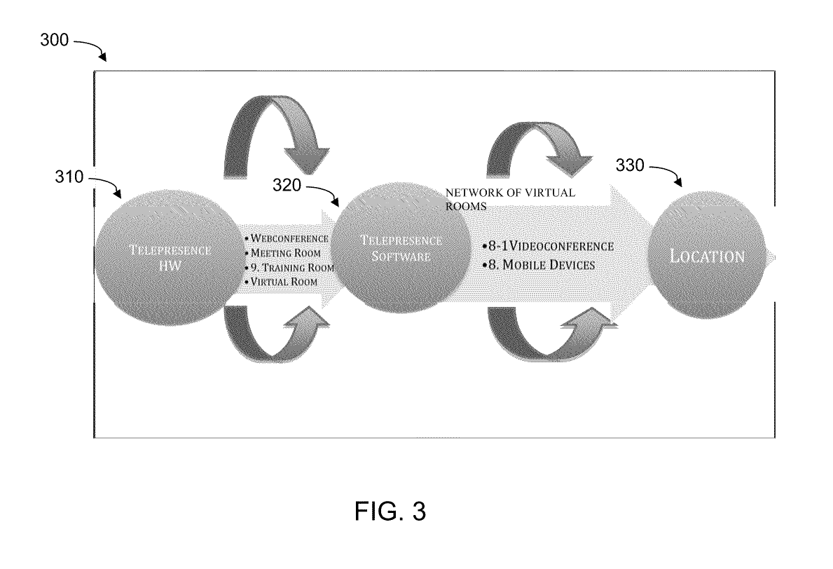

FIG. 3 is an exemplary block diagram depicting a telepresence system in accordance with an embodiment of the present invention. Telepresence system 300 includes telepresence hardware 310, telepresence software 320 and locations 330 in which the hardware and software may be utilized. Telepresence hardware 310 includes the components necessary to enable the telepresence interactions. Telepresence hardware 310 may include, but not limited to, video and audio capture devices, file sharing devices, communication devices, audio to text conversion devices, text to audio conversion devices, display devices, audio reproduction devices, haptic devices, etc. Telepresence hardware 310 may be included in the devices shown in FIG. 1B or portions distributed about the devices shown in FIG. 1B. Telepresence software 320 includes, but not limited to, the software necessary to control the telepresence hardware devices, telepresence applications, telepresence session management software, accounting software, computer operating systems and utilities, etc. Locations 330 include, but not limited to, any location around the world where a wireless link to a telepresence equipped mobile device may be achieved, and fixed locations such as, but not limited to, traditional office settings, network of locations, brick and mortar locations, executive suites, network of offices, virtual offices, meeting rooms, telepresence suites, business lounges, hotels, etc.

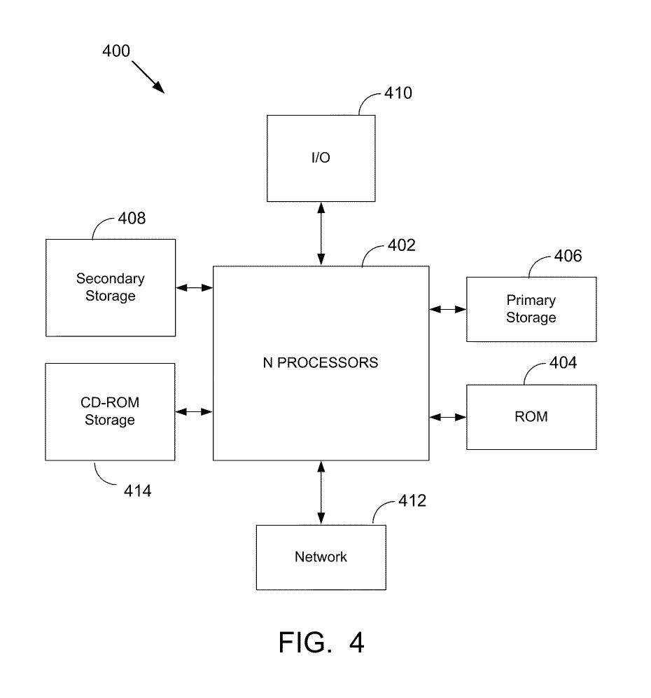

FIG. 4 illustrates a mobile device that, when appropriately configured or designed, may serve as a mobile device 400 for which the present invention may be embodied.

Mobile device 400 includes a quantity of processors 402 (also referred to as central processing units, or CPUs) that may be coupled to storage devices including a primary storage 406 (typically a random access memory, or RAM), a primary storage 404 (typically a read only memory, or ROM). CPU 402 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 404 acts to transfer data and instructions uni-directionally to the CPU and primary storage 406 is used typically to transfer data and instructions in a bi-directional manner. The primary storage devices discussed previously may include any suitable computer-readable media such as those described above. A mass storage device 408 may also be coupled bi-directionally to CPU 402 and provides additional data storage capacity and may include any of the computer-readable media described above. Mass storage device 408 may be used to store programs, data and the like and is typically a secondary storage medium such as a hard disk. It will be appreciated that the information retained within mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications or internet network using an external connection shown generally as a network 412, which may be implemented as a hardwired or wireless communications link using suitable conventional technologies. With such a connection, the CPU might receive information from the network, or might output information to the network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, the functions provided by clients 102 and 104, mobile clients 156, 158 and 160, server devices 106, 108, 166 and 168 and global network 114 as illustrated in FIG. 1B and the portions of the operation of the example software embodiment performed by a user as illustrated in FIG. 2A-F may be performed and/or located outside of the jurisdiction of the USA while the remaining method steps and/or system components of the forgoing embodiments are typically required to be located/performed in the US for practical considerations.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Having fully described at least one embodiment of the present invention, other equivalent or alternative methods of providing mobile telepresence collaborative interaction according to the present invention will be apparent to those skilled in the art. The invention has been described above by way of illustration, and the specific embodiments disclosed are not intended to limit the invention to the particular forms disclosed. For example, the particular implementation of the mobile clients may vary depending upon the particular type network interface or processor used. The devices described in the foregoing were directed to mobile client implementations; however, similar techniques may provide mobile telepresence collaboration interactions to other types of devices such as, but not limited to, handheld electronic games and navigation systems. Implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method executing on one or more processors comprising:
steps for transmitting, over a first wireless link, a first mobile request for creating a first telepresence session;
steps for transmitting, over said first wireless link, telepresence information comprising at least a list of attendees and a scheduled time;
steps for acknowledging a second mobile request, transmitted over a second wireless link, to join said first telepresence session; and
steps for engaging in a real-time telepresence session, created by said first mobile request and said second mobile request, at said scheduled time, wherein users are enabled to participate in telepresence interactions.

2. The method as recited in claim 1, further comprising steps for acknowledging a fixed location request to join said first telepresence session, wherein a user at a fixed location is enabled to participate in said telepresence interactions.

3. The method as recited in claim 1, further comprising steps for receiving one or more telepresence applications utilizing a open application programming interface for extending said telepresence interactions.

4. The method as recited in claim 1, further comprising steps for receiving a list of available telepresence sessions for enabling selection of a desired session.

5. A method executing by one or more processors comprising the steps of:
transmitting, at least partially over a first wireless link from a first mobile communications client to at least one server, a first request for creating a first telepresence session;
transmitting, at least partially over said first wireless link from said first mobile communications client to said at least one server, telepresence information comprising at least a list of attendees and a scheduled time;
acknowledging said at least one server receiving a second request, transmitted at least partially over a second wireless link from a second mobile communications client to said at least one server, to join said first telepresence session;
engaging in a real-time telepresence session, created by said first request and said second request, at said scheduled time, wherein users of said first mobile communications client and said second mobile communications client are enabled to participate in telepresence interactions; and
acknowledging said at least one server receiving a third request, from a fixed location communications client, to join said first telepresence session, wherein a user of said fixed location communications client is enabled to participate in said telepresence interactions.

6. The method as recited in claim 5, wherein clients utilize an open application programming interface (API).

7. The method as recited in claim 6, further comprising the step of receiving, from said at least one server, one or more telepresence applications utilizing said open API for extending said telepresence interactions.

8. The method as recited in claim 5, further comprising the step of receiving, from said at least one server, a list of available telepresence sessions for enabling selection of a desired session.

9. The method as recited in claim 5, wherein said real-time telepresence session further enables document exchange and document viewing.

10. The method as recited in claim 5, wherein said telepresence interactions further comprise videoconferencing.

11. The method as recited in claim 10, wherein said videoconferencing further comprises three-dimensional video.

12. The method as recited in claim 10, wherein audio, associated with said videoconferencing, is converted to subtext for real-time display.

13. The method as recited in claim 12, wherein a language conversion is applied to said subtext.

14. The method as recited in claim 5, wherein said telepresence interactions further comprise webmeetings and webtraining.

15. A system comprising:
means for engaging in telepresence sessions over wireless links using communications clients;
means for connecting said wireless links to enable communication between said engaging means; and
means for managing said telepresence sessions, wherein mobile users operating said communications clients are enabled to engage in real-time telepresence sessions and participate in telepresence interactions.

16. The system as recited in claim 15, further comprising means for engaging in said telepresence sessions, over said network, from fixed locations, wherein fixed location users are enabled to engage said mobile users in said real-time telepresence sessions and participate in said telepresence interactions.

17. The system as recited in claim 15, further comprising means for extending said telepresence interactions.

18. A system comprising:
a plurality of mobile communication devices configurable for telepresence sessions over wireless links, each of said plurality of mobile communication devices comprising a communications client;
a network for connecting said wireless links to enable communication between said plurality of mobile communication devices; and
at least one communications means coupled to a server, which thereby couples said server to said network, said communications means receiving information from said server that is suitable to manage said telepresence sessions, whereby mobile users operating said communications clients are thereby at least enabled, based on said telepresence session management information, to engage in real-time telepresence sessions and participate in telepresence interactions.

19. The system as recited in claim 18, further comprising a plurality of fixed location telepresence sites configured for telepresence sessions over said network, wherein fixed location users are enabled to engage said mobile users in said real-time telepresence sessions and participate in said telepresence interactions.

20. The system as recited in claim 18, wherein said communications clients utilize an open application programming interface (API).

21. The system as recited in claim 20, further comprising one or more telepresence applications utilizing said open API for extending said telepresence interactions, said one or more telepresence applications being stored on said at least one server.

22. The system as recited in claim 18, wherein said at least one server further manages a list of available telepresence sessions for enabling user selection of a desired session.

23. The system as recited in claim 18, wherein said real-time telepresence sessions further enable document exchange and document viewing.

24. The system as recited in claim 18, wherein said telepresence interactions further comprise videoconferencing.

25. The system as recited in claim 24, wherein said videoconferencing further comprises three-dimensional video.

26. The system as recited in claim 24, wherein audio, associated with said videoconferencing, is converted to subtext for real-time display.

27. The system as recited in claim 26, wherein a language conversion is applied to said subtext.

28. The system as recited in claim 18, wherein said telepresence interactions further comprise webmeetings and webtraining.

29. A computer program product residing on or being distributed across one or more computer readable mediums having a plurality of instructions stored thereon which, when executed by one or more associated processors, cause the one or more processors to:
transmit, at least partially over a first wireless link from a first mobile communications client to at least one server, a first request for creating a first telepresence session;
transmit, at least partially over said first wireless link from said first mobile communications client to said at least one server, telepresence information comprising at least a list of attendees and a scheduled time;
acknowledge said at least one server receiving a second request, transmitted at least partially over a second wireless link from a second mobile communications client to said at least one server, to join said first telepresence session; and
engage in a real-time telepresence session, created by said first request and said second request, at said scheduled time, wherein users of said first mobile communications client and said second mobile communications client are enabled to participate in telepresence interactions.

30. The computer program product as recited in claim 29, further comprising instructions for acknowledging said at least one server receiving a third request, from a fixed location communications client, to join said first telepresence session, wherein a user of said fixed location communications client is enabled to participate in said telepresence interactions.

31. The computer program product as recited in claim 29, wherein clients utilize an open application programming interface (API).

32. The computer program product as recited in claim 31, further comprising instructions for receiving, from said at least one server, one or more telepresence applications utilizing said open API for extending said telepresence interactions.

33. The computer program product as recited in claim 29, further comprising instructions for receiving, from said at least one server, a list of available telepresence sessions for enabling selection of a desired session.

34. The computer program product as recited in claim 29, wherein said real-time telepresence session further enables document exchange and document viewing.

35. The computer program product as recited in claim 29, wherein said telepresence interactions further comprise videoconferencing.

36. The computer program product as recited in claim 35, wherein said videoconferencing further comprises three-dimensional video.

37. The computer program product as recited in claim 35, wherein audio, associated with said videoconferencing, is converted to subtext for real-time display.

38. The computer program product as recited in claim 37, wherein a language conversion is applied to said subtext.

39. The computer program product as recited in claim 29, wherein said telepresence interactions further comprise webmeetings and webtraining.
